(19) United States
(12) Patent Application Publication
(10) Pub. No.: US 2012/0038513 A1
(43) Pub. Date: Feb. 16, 2012

(54) CENTRALIZED ANTENNA INTERFACE FOR WIRELESS NETWORKS

(76) Inventors: Zhixi Li, Vienna, VA (US); Thomas Williston Head, Chantilly, VA (US); Aiman Shabsigh, McLean, VA (US); Peter Frederick Krug, Kanata (CA); Richard Cuthill, Reston, VA (US)

(21) Appl. No.: 12/855,846

(22) Filed: Aug. 13, 2010

(51) Int. Cl. H01Q 3/00

(52) U.S. Cl. 342/372; 342/374

(57) ABSTRACT

An antenna interface system, device, method and program allow access to a centralized antenna interface by establishing connection to a server via a first network connection, wherein the server includes a user interface configured to establish a communication connection between the antenna interface system and the user of the access device. The server also includes one or more antenna control programs which when executed provide the command signals, and a second network connection establishes a communication connection between the server and converters that transmit the command signals from the server to the antennas. Each converter is located in the vicinity of one or more antennas and the antennas are connected to the converters so as to receive the command signals. The command signals are used for making adjustments to and gathering information for antenna parameters of the antennas.

### BACKGROUND OF THE INVENTION

1. Field of the Invention

The present invention relates generally to wireless networks such as deployment, self-healing, self-organizing and optimization networks. In particular, the present invention relates to real-time wireless network tuning by making adjustments to antenna parameters through a central antenna interface.

2. Description of the Related Art

A wireless network can be optimized in real-time if the radiation patterns, e.g., azimuth directions and elevation tilt, of the remote controllable antennas are adjusted without removing the remote controllable antennas from service. In conventional wireless systems, in order to optimize performance of the remote controllable antennas, the wireless system must be equipped with Antenna Line Devices (ALDs) that contain remote control and monitoring facilities (e.g., ALD controllers). The Antenna Interface Standards Group (AISG) defined one data interface between the ALD controllers and the remote controllable antennas. In particular, the AISG defines the requirements of a three-layer (1, 2, and 7) protocol model that is a compact form of an Open Systems Interconnection (OSI) seven-layer reference model.

An Operational Maintenance Center (OMC) controls the ALDs located at different sites based on certain network management protocols. The ALD controllers are installed at every base transceiver station (BTS) and are set as nodes in the network to provide as a data interface between the OMC and remote controllable antennas. In this conventional wireless system structure, the ALD controllers are operated as proprietary controllers, known also in the industry as Central Control Units (CCU) or Master Control Units (MCU). As noted above, the ALD controllers must be distributed at each BTS, and include control software to compile the high level commands from the OMC as well as management software executed by an associated processor.

An example of a conventional wireless system is shown in FIG. 1. The wireless network 100 of FIG. 1 refers to any type of computer network that includes at least some wireless connections, and is commonly associated with a telecommunications network whose interconnections may be implemented without the use of wires such as with electromagnetic waves or radio waves. As shown in FIG. 1, the system 100 includes an OMC network management device 101, an OMC network server 102, an operator internal network 103 and a proprietary AISG controller 104. The proprietary AISG controller is connected to a plurality of antennas 105, which provide wireless services to respective coverage areas 106.

The OMC device 101 is part of the OMC and provides command signals to the AISG controller 104 for optimizing operation of the antennas 105 in the wireless network 100. The OMC device 101 provides command signals to the AISG controller 104 through OMC network server 102 and the operator internal network 103. In this conventional wireless system 100, the OMC device 101 sends command signals to AISG controller 104 and the antennas 105 through the Local Area Network (LAN) or Wide Area Network (WAN) based on network management protocols such as Simple Network Management Protocol (SNMP), TCP/IP, even Common Public Radio Interface (CPRI).

The proprietary AISG controller 104 is installed at a base transceiver station (not shown) and controls adjustments to the antennas 105 based on command signals from the OMC device 101 of the OMC. Every AISG controller must be able to compile high level commands signals from the OMC device 101. Additionally, the AISG controller 104 also includes management software executed by an associated processor in order to make adjustments to the antennas 105 for optimizing the wireless services provided to the coverage areas 106.

Thus, the AISG controller 104 requires sophisticated control and management software for effecting adjustments to the antennas, which makes the AISG controller 104 a central controlling component for making adjustments to the antennas 105. Additionally, the sophisticated management and control software included in the AISG controller 104 is expensive to develop and maintain, which increases the cost of maintaining optimization of the wireless network 100.

Therefore, it would be useful to implement a central antenna interface for performing real-time adjustment of antenna parameters in a wireless network, which is less expensive than the conventional approach of using the proprietary ALD controllers (i.e., distributed at each BTS) that can be fully removed from an operator's network.

### SUMMARY OF THE INVENTION

An embodiment of the invention is directed to an antenna interface system for providing command signals to antennas in a wireless network. The antenna interface system includes, in part, an access device, a server, converters and antennas. The access device can be a portable device that allows a user to access the antenna interface system by establishing connection to the server via a first network connection, wherein the server includes a user interface configured to establish a communication connection between the antenna interface system and a user of the access device. The user interface can be an application program interface or a graphical user interface.

Additionally, the server includes one or more antenna control programs that when executed provide the command signals to the antennas. The server also includes application programs, wherein the antenna control programs are among the application programs. The application programs are stored on a non-transitory computer-readable recording medium, and a processor in the server executes the application programs so as to provide the command signals to the antennas. The converters are configured to transmit the command signals from the server to the antennas. Specifically, a second network connection establishes a communication connection between the server and the converters, which is for example an Ethernet connection.

Each converter is located in the vicinity of one or more antennas, and the antennas are connected to the converters so as to receive the command signals. In alternative embodiments, the converters can be embedded in base station transceivers or antennas. The converters perform communications to and from the antennas by being configured to receive control signals or messages from the server, wherein the control messages are encoded into Layer 2 frames encapsulated in Ethernet message format. The converters can identify the Layer 2 frames from the Ethernet message format and send the Layer 2 frames to the antennas using a physical layer protocol in conformance with antenna control specification of the plurality of antennas. The converters can also receive reply messages from the antennas, wherein the reply messages are encoded into Layer 2 frames sent using the physical layer protocol in conformance with the antenna control specification of the antennas. The converters then encapsulate the Layer 2 frames of the reply message in Ethernet message format, and send the Ethernet message format representative of the replay message to the server.

The command signals are used for making adjustments to and gathering information for antenna parameters of the antennas. The antenna parameters are related to, for example, elevation tilt, azimuth steering, azimuth bandwidth, antenna calibration, information for enabling and disabling an antenna, firmware downloads and antenna inventory information. The antenna inventory information includes, but is not limited to, manufacturer information, model numbers and serial numbers related to the antennas.

As an alternative to connecting the access device to the server via the first network connection, in another embodiment, the access device establishes a network connection to the server via a third network connection. Additionally, in another embodiment, the access device establishes a connection directly to at least one converter via a fourth network connection. In this embodiment, the access device would include a user interface and one or more antenna control programs configured to provide command signals to the antennas via the fourth network connection. The access device also includes application programs, wherein the antenna control programs would be among the application programs. The application programs are stored on a non-transitory computer-readable recording medium, and a processor executes the application programs so as to provide the command signals to the antennas.

The first, third and fourth network connections include, but are not limited to, a coaxial cable interface, Universal Serial Bus (USB) interface, a Personal Computer Memory Card International Association (PCMCIA) interface; or wireless interface that also allows the exchange of information across one or more wireless communication networks such as cellular or short-range (e.g., IEEE 802.11 wireless local area networks (WLANS)).

The antenna interface system also includes a database configured to store network parameters and information related to the antenna parameters and the antennas. Additionally, in an embodiment, a switch is configured to be connected to the communication network connection and to two or more converters so as to switch between the two or more converters for sending command signals to respective antennas.

An embodiment of the invention is directed to a method of establishing an antenna interface for providing command signals from a server to antennas in the wireless network. The method includes establishing the first network connection between an access device and the server; providing the user interface configured to establish a communication connection between the server and the access device; establishing the second network connection between the server and the converters; and providing the command signals from the server to the antennas via the converters.

The method also includes identifying all the antennas connected to the converters based on antenna parameters stored in a database, and if the connected antennas are not able to be identified, creating new antenna parameters. All the connected antennas are assigned a unique address, which is stored in the database. Additionally, the status of the antennas connected to the converters is checked, and it is determined if the antennas are ready to receive commands signals from the server. If an antenna or group of antennas are determined not to be ready to receive command signals for a predetermined amount time, then the antenna or group of antennas are considered not to be operational and a repair message is sent. The method further includes determining if the command signals sent to the antennas have been executed, and updating the status of the antennas in the database. A confirmation message is sent to the server regarding the execution of the command signals by the antennas.

In another embodiment, a method is directed to establishing an antenna interface for providing command signals from an access device to the antennas. This method includes establishing a network connection between the access device and at least one of the converters; providing a user interface configured to establish a communication connection between the access device and a user of the access device; and providing the command signals from the access device to the antennas via the converters and the network connection.

An embodiment of the invention is directed to a program stored on a non-transitory computer-readable recording medium for establishing an antenna interface for providing command signals from the server to the antennas, wherein the program causes the server to execute the method of the present invention noted above. Additionally, an embodiment of the invention is directed to a program stored on a non-transitory computer-readable recording medium for establishing an antenna interface for providing command signals from the access device to the antennas, wherein the program causing the access device to execute the method of the present invention noted above.

### BRIEF DESCRIPTION OF THE DRAWINGS

In the drawings, like reference numbers generally indicate identical, functionally similar and/or structurally similar elements. Embodiments of the invention will be described with reference to the accompanying drawings, wherein:

FIG. 1 illustrates a conventional system for providing command signals to antennas in a wireless network;

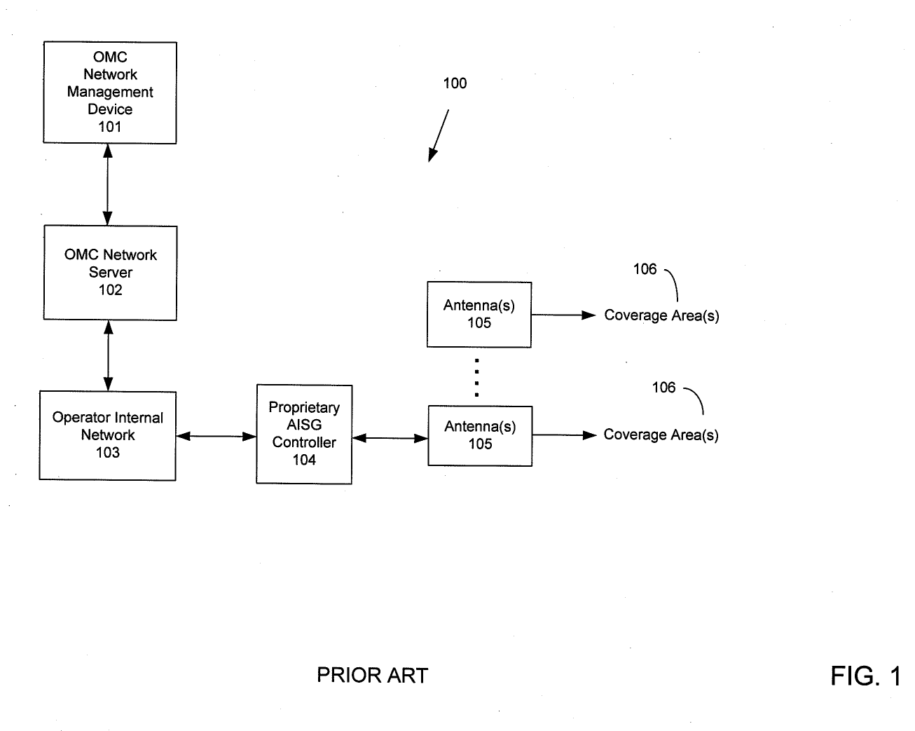

FIG. 2 illustrates an antenna interface system for providing command signals to antennas in a wireless network in accordance with an embodiment of the invention;

FIG. 3 illustrates a flowchart of a method for providing an antenna interface for providing command signals to antennas in a wireless network in accordance with an embodiment of the invention;

FIG. 4 illustrates another flowchart of a method for providing an antenna interface for providing command signals to antennas in a wireless network in accordance with an embodiment of the invention;

FIG. 5 illustrates in more detail an antenna interface device for providing command signals to antennas in a wireless network in accordance with an embodiment of the invention; and

FIG. 6 illustrates in more detail an access device for providing command signals to antennas in a wireless network in accordance with an embodiment of the present invention.

Additional features are described herein, and will be apparent from the following description of the figures.

### DETAILED DESCRIPTION OF THE INVENTION

In the description that follows, numerous details are set forth in order to provide a thorough understanding of the invention. It will be appreciated by those skilled in the art that variations of these specific details are possible while still achieving the results of the invention. Well-known elements and processing steps are generally not described in detail in order to avoid unnecessarily obscuring the description of the invention.

In the drawings accompanying the description that follows, often both reference numerals and legends (labels, text descriptions) may be used to identify elements. If legends are provided, they are intended merely as an aid to the reader, and should not in any way be interpreted as being limiting.

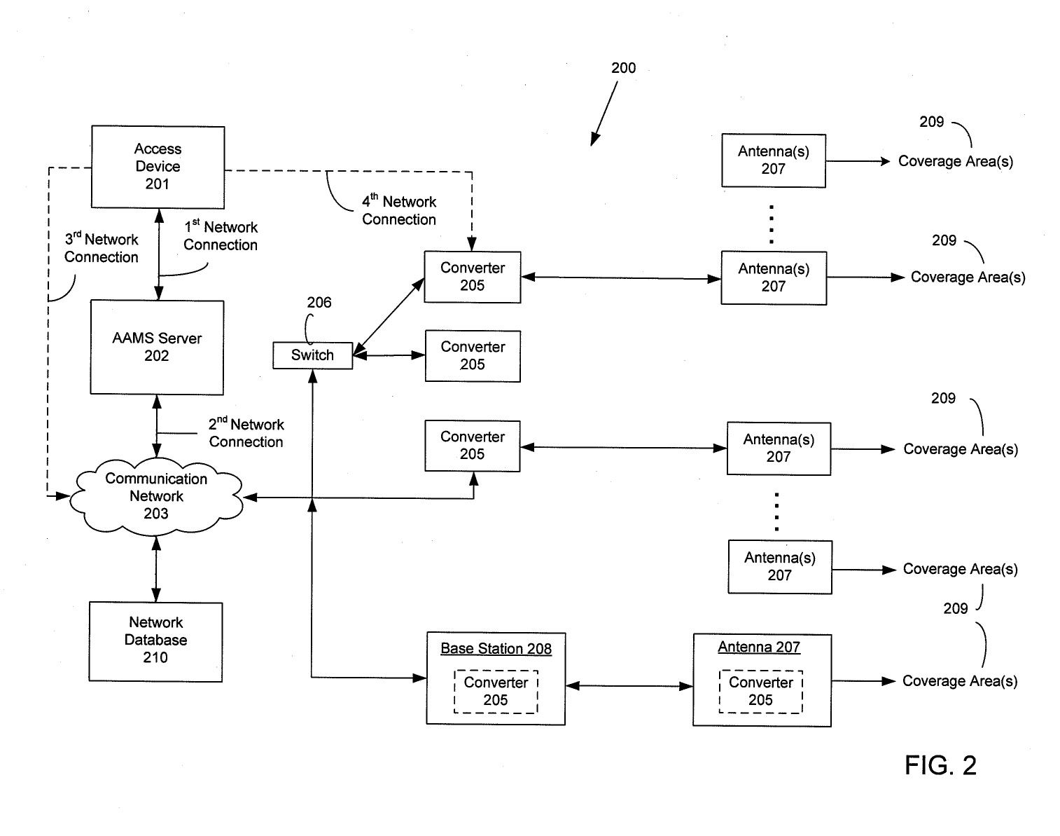

FIG. 2 illustrates an antenna interface system for providing command signals to antennas in a wireless network in accordance with an embodiment of the invention. FIG. 2 is an exemplary implementation of a centralized interface system 200 for controlling and monitoring antennas 207 remotely according to, but not limited by, the AISG standards.

The antenna interface system 200 shown in FIG. 2 includes, in part, an access device 201, an Advanced Antenna Management System (AAMS) server 202, converters 205 and antennas 207. The access device 201 can be, for example, a portable access device such as a laptop or other portable computing device that allows a user to access the antenna interface system 200 by establishing a connection to the AAMS server 202, wherein the AAMS server 202 includes a user interface configured to establish a communication connection between the antenna interface system 200 and a user of the access device 201 via a first network connection. The user interface can be an application program interface or a graphical user interface.

The AAMS server 202 also includes one or more AAMS antenna control programs that when executed provide command signals for making adjustments to and/or obtaining information from the antennas 207 via the converters 205. The antennas 207 are most likely remote electrical tilt (RET) antennas, but could also be tower-mounted amplifiers (TMAs). The AAMS control programs are software that is installed and run on the AAMS server 202. The AAMS server 202 generates commands signals that are transmitted via a second network connection through the communication network 203 to the converters 205, and the converters 205 are configured to transmit the command signals from the AAMS server 202 to the antennas 207. The second network connection that establishes a communication connection between the server AAMS server 202 and the converters 205 is, for example, an Ethernet connection.

The AAMS control programs can be installed on a stand-alone AAMS server 202, or can also be integrated into the ensemble radio network management software platform provided by an operator. The AAMS server 202 running the AAMS antenna control programs or software is able to manage hundreds of antennas 207 remotely through the communication network 203.

The AAMS server 202 communicates commands signals to the converters 205 by encapsulating Layer 2 (e.g., high-level data link (HDLC)) antenna interface messages into Ethernet (e.g., TCP/IP) format. The creation of Layer 2 messages at the centralized AAMS server 202 eliminates the need for heavy control software at an Antenna Line Device (ALD) controller, Central Control Unit (CCU) or Master Control Unit (MCU). The AAMS antenna control programs running on the AAMS server 202 results in the AAMS server 202 being the central control device for making adjustments to and/or gathering information from the antennas 207, instead of the individual ALDs controller, CCUs and MCUs in conventional wireless systems. Thus, control and monitoring of the antennas 207 in the system 200 are centralized by the AAMS server 202.

Each converter 205 is located in the vicinity of one or more antennas 207, and the antennas 207 are connected to the converters 205 so as to receive the command signals. In alternative embodiments, the converters 205 can be embedded in a base station transceiver 208 or an antenna 207. The command signals are used for making adjustments to and gathering information for antenna parameters of the antennas 207 for optimizing the service provided to the coverage areas 209. The antenna parameters relate to, for example, elevation tilt, azimuth steering, azimuth bandwidth, antenna calibration, information for enabling and disabling an antenna, firmware downloads and antenna inventory information. The antenna inventory information includes, but is not limited to, manufacturer information, model numbers and serial numbers related to the antennas 207.

The converters 205 are compatible with a commonly used AISG ALD control and monitoring protocol specifications that call for the use of an AISG protocol (Layer 7) over the HDLC (Layer 2), over RS-485 (Layer 1), and the provisions of DC power for antenna line devices requiring power to operate. For example, on the downstream side, a converter 205 takes AISG antenna status and control messages that are already encoded into HDLC frames and encapsulated into TCP/IP messages by the AAMS server, discovers the HDLC frames from the TCP/IP messages, and sends the HDLC frames out over an RS-485 physical layer protocol in conformance with the AISG antenna control specification. On the upstream side, the converter 205 encapsulates HDLC frames containing AISG control and status signals from the ALDs (e.g., antennas 207) into TCP/IP messages to the AAMS server 202. Because the converter 205 does not process HDLC frames or AISG status and control messages, it is less expensive to build and operate than conventional proprietary ALD controllers, CCU or MCUs. Each antenna site can be equipped with one or more converters 205 that can control multiple antennas 105, for example, by using a daisy chain structure.

As an alternative to connecting the access device 201 to the AAMS server 202, the access device 201 can establish a network connection to the AAMS server 202 via a third network connection and the communication network 203. Additionally, the access device 201 can also establish a connection directly to at least one converter 205 via a fourth network connection. In this embodiment, the access device 201 would include a user interface and one or more AAMS antenna control programs or software configured to provide command signals to the antennas 207. The first, third and fourth network connections include, but are not limited to, a coaxial cable interface, Universal Serial Bus (USB) interface, a Personal Computer Memory Card International Association (PCMCIA) interface; or wireless interface that also allows the exchange of information across one or more wireless communication networks such as cellular or short-range (e.g., IEEE 802.11 wireless local area networks (WLANS)).

The antenna interface system 100 also includes a database 210 configured to store network parameters and information related to the antenna parameters and the antennas 207. The network parameters may include locations of base stations (BS) and satellite stations (SS), and height of BS and SS antennas relative to terrain and sea level. Antenna parameters may include, elevation tilt, azimuth steering, azimuth bandwidth, antenna calibration, information for enabling and disabling an antenna, firmware downloads and antenna inventory information. The antenna inventory information includes, but is not limited to, manufacturer information, model numbers and serial numbers related to the antennas 207.

Additionally, in an embodiment, a switch 206 is configured to be connected to the AAMS server 202 via the communication network 203 and to two or more converters so as to switch between the two or more converters for sending command signals to antennas 207. By using the switch 206, antennas 207 located at several base stations can be adjusted as a group provided that they are connected to the switch 206 and controlled by the AAMS server 202, which is also connected to the switch 206 through the communication network 203.

In another embodiment, the antennas 207 can be controlled via their coaxial RF ports without interfering with existing communications in a base station system. In this case, the use of separate AISG ports is not necessary because current local ALD control units or future converter box are built into the base station (BS) transceivers 208. Therefore, the centralized AAMS server 202 or the access device 201 only needs to communicate with the remote BS transceivers 208 through certain socket connections to perform local command and data transmission to and from the antennas 207. In yet another embodiment, the converters 205, which are of simple construction, can be embedded in the antennas 207 so that a Layer 1 interface is not needed in network connections.

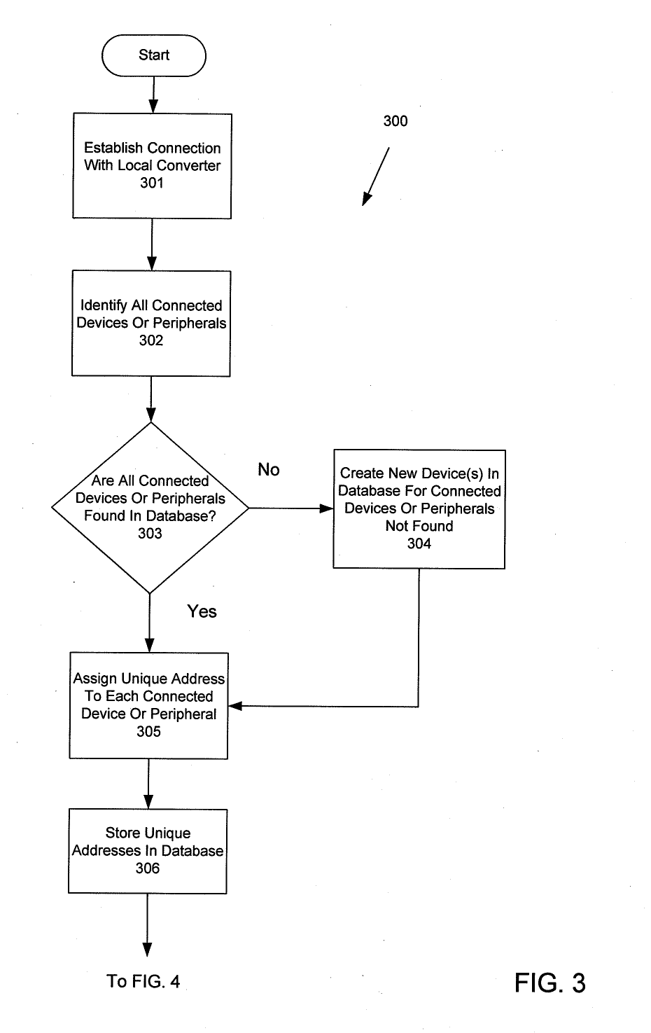

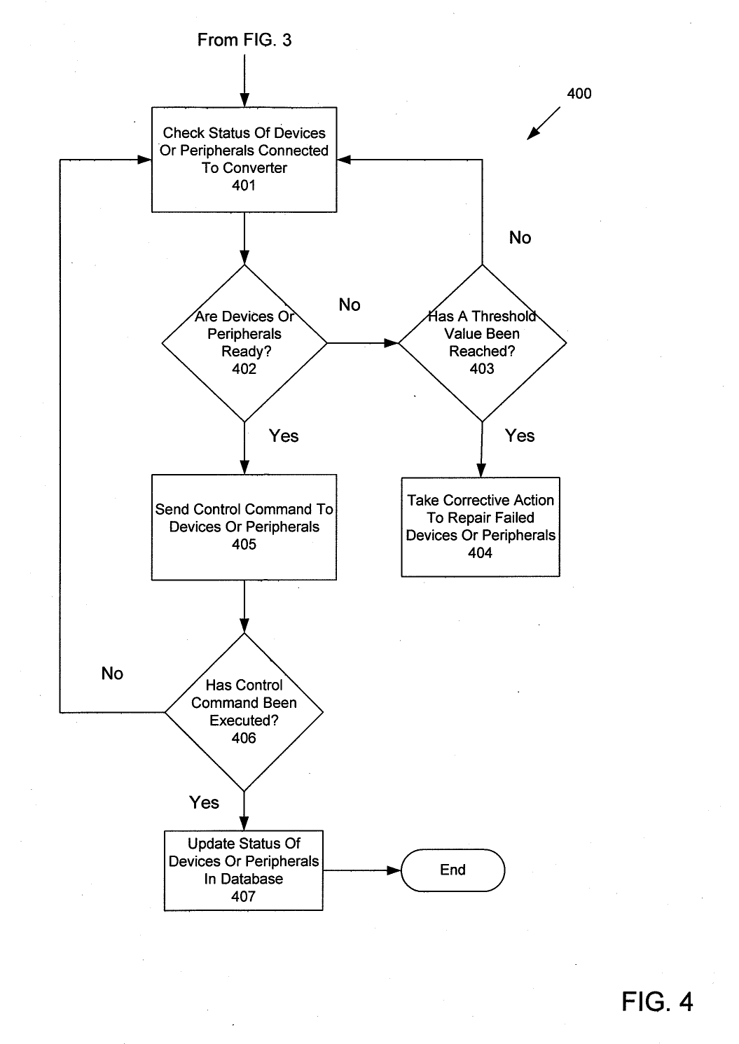

FIGS. 3 and 4 illustrate flowcharts of methods for providing an antenna interface for transmitting command signals to antennas in a wireless network in accordance with embodiments of the invention.

FIG. 3 shows the method 300. In step 301, the AAMS server 202 establishes a connection with the converters 205 though the communication network 203. As an alternative to the use of the AAMS server 202, the access device 201 can establish a connection directly to at least one converter 205. In this embodiment, the access device 201 would include a user interface and one or more AAMS antenna control programs or software configured to provide command signals to the antennas 207.

In step 302, the AAMS server 202 attempts to identify all the antennas 207 connected to the converters 205 based on antenna parameters stored in a database 210. In step 303, it is determined if the connected antennas 207 are able to be identified. In step 304, if the antennas 207 connected to the converters 205 cannot be identified, then the AAMS server 202 creates new antenna parameters to be stored in the database 210 for the connected antennas 207 that could not indentified. In step 305, all the antennas 207 connected to the converters 205 are assigned unique addresses, which are stored in the database 210 in step 306.

FIG. 4 shows the method 400. In step 401, the status of the antennas 207 connected to the AAMS server 205 is checked. In step 402, it is determined by the AAMS server 202 if the antennas connected to the converters 205 are ready to receive command signals from the AAMS server 202. In step 402, if it is determined that the antennas are not ready, then in step 403, it is determined if a threshold value has been reached. The threshold value may include a number of attempts or a predetermined time period in which to receive information indicating that the antennas 207 are in an operational or ready state. If it is determined in step 403 that the threshold value has been reached, then a repair message is sent regarding the antennas 207. Failure to receive information indicating that the antennas 207 are in an operational or ready state could be an indication that the antennas 207 are in need of repair.

On the other hand, in step 403, if it is determined that the threshold value has not been reached, then the AAMS server 202 will continue to try to determine if the antennas 207 are in an operational or ready state until either the information is received or the threshold value has been reached. In step 402, if it is determined that the antennas 207 are in an operational or ready state to receive command signals from the AAMS server 202, then is step 405 the command signals are sent from the AAMS server 202 to the antennas 207 via the converters 205 and the communication network 203.

Each converter 205 is located in the vicinity of one or more antennas 207, and the antennas 207 are connected to the converters 205 so as to receive the command signals. The command signals are used for making adjustments to and gathering information for the antenna parameters of the antennas 207 for optimizing the service provided to the coverage areas 209. The antenna parameters relate to, for example, elevation tilt, azimuth steering, azimuth bandwidth, antenna calibration, information for enabling and disabling an antenna, firmware downloads and antenna inventory information.

In step 406, it is determined by the AAMS server 202 if the command signals have been executed by the antennas 207. In step 406, if it is determined that the command signals have not be executed by the antennas 207, then the AAMS server 202 will continue check the status of the antennas, as in step 401. However, in step 406, if it is determined by the AAMS server 202 that the command signals have been executed by the antennas 207, then in step 407 the status of the antennas 207 that have executed the command signals from the AAMS server 202 are updated in the database 210. Confirmation that the command signals from the AAMS server 202 have been executed by the antennas 207 can be based on, for example, a confirmation message received from the antennas 207 via the converters 205 and the communication network 203.

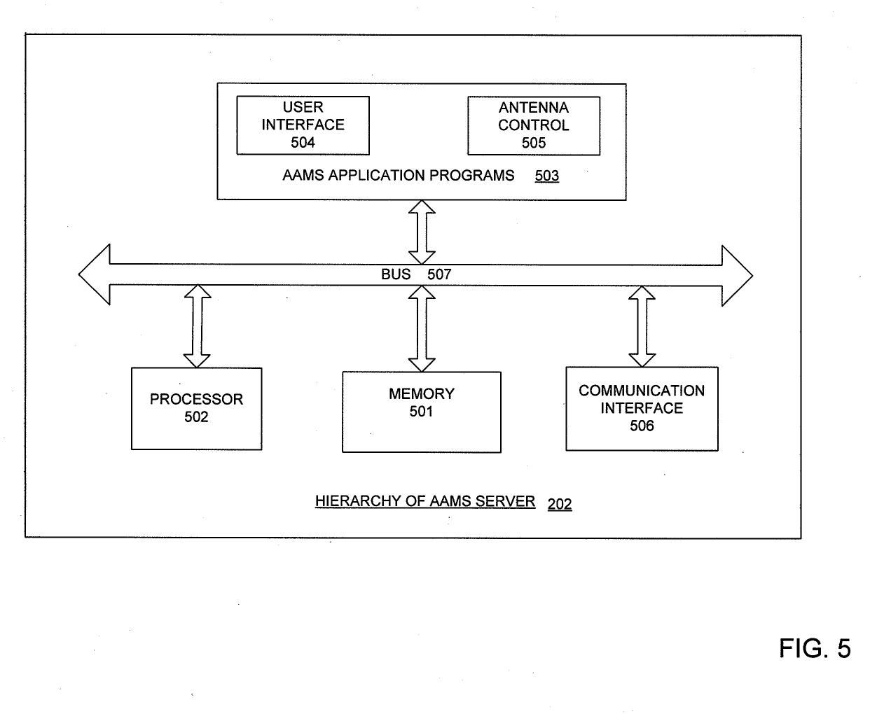

FIG. 5 is a more detailed description of the AAMS server 202 illustrated in FIG. 2. In FIG. 5, the AAMS server 202 includes a memory 501, a processor 502, AAMS application programs 503, a communication interface 506, and bus 507. The memory 501 can be a non-transitory computer-readable storage medium used to store executable instructions, or computer program thereon. The memory 501 may include a read-only memory (ROM), random access memory (RAM), programmable read-only memory (PROM), erasable programmable read-only memory (EPROM), a smart card, a subscriber identity module (SIM), or any other medium from which a computing device can read executable instructions or a computer program. The term “computer program” is intended to encompass an executable program that exists permanently or temporarily on any computer-readable storage medium as described above.

A computer program is also intended to include an algorithm that includes executable instructions stored in the memory 501 that are executable by the processors 502, which may be facilitated by one or more of the application programs also stored on the memory 501. The application programs may include, but are not limited to, an operating system or any special computer program that manages the relationship between application software and any suitable variety of hardware that helps to make-up a computer system or computing environment of the AAMS server 202.

The AAMS application programs 503 provide the primary function of enabling the AAMS server to operate as a central antenna interface for performing real-time adjustment of antenna parameters of the antennas 205 in the wireless network 200. It should be understood my one of ordinary skill in the art that the AAMS application program are stored on a non-transitory computer-readable medium and executed by the processor 502 for providing the centralized antenna interface functions, as described above with reference to FIGS. 3 and 4.

The AAMS application programs 503 also include a user interface 504 configured to establish a communication connection between the antenna interface system 200 and a user of, for example, the access device 201. The user interface 504 can be implemented as application program interface or a graphical user interface. The AAMS application programs 503 also includes one or more AAMS antenna control programs, which when executed by the processor 502 provide command signals to the antennas 207 via the converters 205 for making adjustments to and/or obtaining information from the antennas 207. The AAMS application programs 503 executed by the AAMS server 202, allows the AAMS server 202 to centrally control and manage hundreds of antennas 207 remotely through the communication network 203 using a low-cost converter 205.

That is, each converter 205 is located in the vicinity of one or more antennas 207, and the antennas 207 are connected to the converters 205 so as to receive the command signals from AAMS server 202. In alternative embodiments, the converters 205 can be embedded in a base station transceiver 208 or an antenna 207. The command signals are used for making adjustments to and gathering information for the antenna parameters of the antennas 207 for optimizing the service provided to the coverage areas 209.

The communication interface 506 provides for two-way data communications from the AAMS server 202 to the rest of the wireless network 200. By way of example, the communication interface 506 may be a digital subscriber line (DSL) card or modem, an integrated services digital network (ISDN) card, a cable modem, or a telephone modem to provide a data communication connection to a corresponding type of telephone line for connection to the communication network 203.

Further, the communication interface 506 may also include peripheral interface devices, such as a Universal Serial Bus (USB) interface, a Personal Computer Memory Card International Association (PCMCIA) interface, and the like. The communication interface 506 also allows the exchange of information across one or more wireless communication networks. Such networks may include cellular or short-range, such as IEEE 802.11 wireless local area networks (WLANS). And, the exchange of information may involve the transmission of radio frequency (RF) signals through an antenna (not shown). Additionally, general communication between the components in the AAMS server 202 is provided via the electrical bus 507.

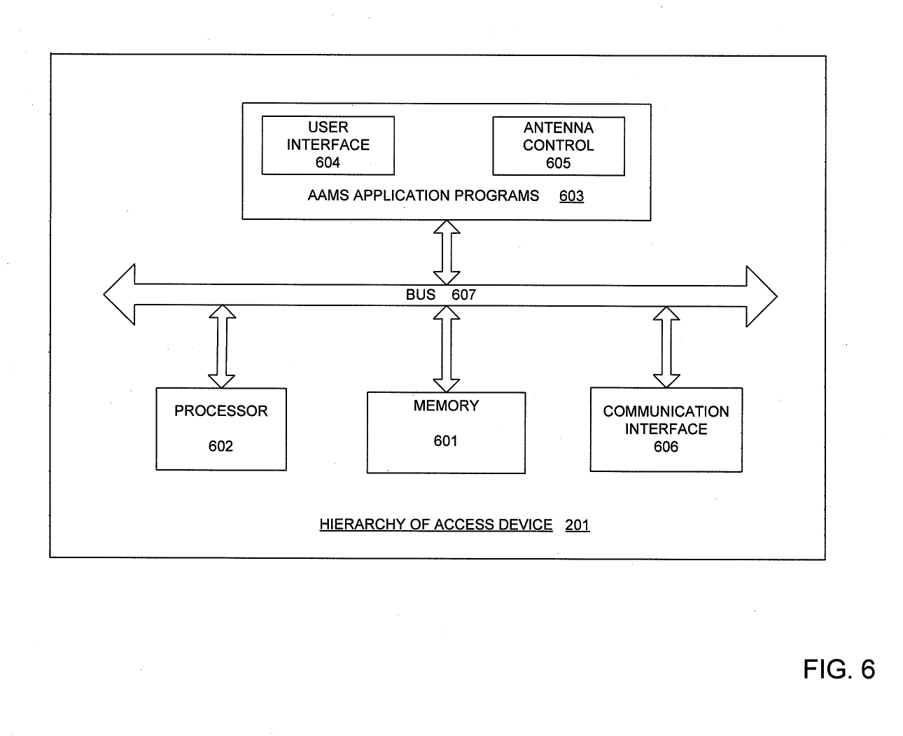

FIG. 6 is a more detailed description of the access device 201 illustrated in FIG. 2. FIG. 6 is different from FIG. 5 in that FIG. 6 is directed to an embodiment of the invention where the access device 201 establishes a connection to at least one converter 205 without the need to connect to the AAMS server 202. In this embodiment, the access device 201 would include the AAMS application programs and the subsystems to enable the access device 201 to perform the centralized antenna interface functions, as described above with reference to FIGS. 3 and 4.

More specifically, in FIG. 6, the access device 201 includes a memory 601, a processor 602, AAMS application programs 603, a communication interface 606, and bus 607. The memory 601 can be a non-transitory computer-readable storage medium used to store executable instructions, or computer program thereon. The memory 601 may include a read-only memory (ROM), random access memory (RAM), programmable read-only memory (PROM), erasable programmable read-only memory (EPROM), a smart card, a subscriber identity module (SIM), or any other medium from which a computing device can read executable instructions or a computer program. The term “computer program” is intended to encompass an executable program that exists permanently or temporarily on any computer-readable storage medium as described above.

The computer program is also intended to include an algorithm that includes executable instructions stored in the memory 601 that are executable by the processors 602, which may be facilitated by one or more of the application programs also stored on the memory 601. The application programs may also include, but are not limited to, an operating system or any special computer program that manages the relationship between application software and any suitable variety of hardware that helps to make-up a computer system or computing environment of access device 201.

The AAMS application programs 603 are also stored on a non-transitory computer-readable medium and executed by the processor 602 for providing the centralized antenna interface functions, as described above with reference to FIGS. 3 and 4. The AAMS application programs 603 also include user interface 604 configured to establish a communication connection between the access device 201 and a user of the access device 201. The user interface 604 can be implemented as application program interface or a graphical user interface. The AAMS application program also includes one or more AAMS antenna control programs 605, which when executed by the processor 602 provide command signals to the antennas 207 via the converters 205 for making adjustments to and/or obtaining information from the antennas 207. The AAMS application programs 603 executed by the access device 201, allow the access device 201 to centrally control and manage antennas 207 remotely via a low-cost converter 205.

The communication interface 606 provides for two-way data communications from the access device 201. The communication interface may include peripheral interface devices, such as a Universal Serial Bus (USB) interface, a Personal Computer Memory Card International Association (PCMCIA) interface, and the like. The communication interface 606 may also allows the exchange of information across one or more wireless communication networks. Such networks may include cellular or short-range, such as IEEE 802.11 wireless local area networks (WLANS). And, the exchange of information may involve the transmission of radio frequency (RF) signals through an antenna (not shown). Additionally, general communication between the components in the AAMS server 202 is provided via the electrical bus 607.

With the embodiments of the present invention as described above with reference to FIGS. 2-6, a large number of current computerized AISG antenna controllers (e.g., proprietary ALD controllers, CCU or MCUs) can be substituted by the simple and low-cost converters 205. These low-cost converters 205 can complete the signal format transform between a networked technology such as TCP/IP and a local serial connection technology such as RS-485. However, the encoding/decoding of Layer 2 messages into/from Layer 1 messages can be more universal.

Additionally, AAMS application programs 503, 603 running on a dedicated AAMS server 202 or the access device 201 form a key part of the implementation of this invention. In our case, the primary station becomes the AAMS server 202 or the access device 201 instead of individual AISG controllers (i.e., proprietary ALD controllers, CCU or MCUs). The AAMS server 202 or the access device 201 will be able to manage hundreds of base station antennas 207 remotely. It is unnecessary to put an expensive antenna interface server at every base station, because the processing of all messages higher than Layer 2 will be handled by the centralized AAMS server 202 or the access device 201.

The embodiments of the present invention as described with reference to FIGS. 2-6, provide the following distinct advantages over conventional wireless systems:

1) global optimization of a wireless communication network by adjusting all base station antennas simultaneously using a centralized interface control system;

2) management of hundreds of AISG antennas or antenna groups automatically by use of simple converter devices and one centralized antenna management device (prior art systems require time-consuming individual adjustments with site visits or the use of expensive remotely located antenna controllers to control antenna line devices);

3) compatibility with multiple antenna vendors, multiple network technologies, multiple communication protocols, and multiple generation base stations;

4) integration with an entire wireless network management system or implementation as a stand-alone system;

5) simplified system upgrading using a centralized interface (e.g., clicking one button on the desk device without site visits); and

6) reduced overall network management cost by replacing expensive individual controllers with inexpensive converters.

From the description provided herein, those skilled in the art are readily able to combine software created as described with the appropriate general purpose or special purpose computer hardware for carrying out the features of the invention. Additionally, it should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claim.

What is claimed is:

1. An antenna interface system for providing command signals to a plurality of antennas in a wireless network, comprising:
an access device;
a server including 1) a user interface configured to establish a communication connection between the antenna interface system and the access device, and 2) an antenna control program configured to provide the command signals to the plurality of antennas;
a first network connection configured to establish a network connection between the access device and the server;
a plurality of converters configured to transmit the command signals from the server to the plurality of antennas, each converter being located in the vicinity of one or more antennas of the plurality of antennas; and
a second network connection configured to establish a communication connection between the server and the plurality of converters,
wherein the plurality of antennas are connected to the plurality of converters so as to receive the command signals, the command signals being used for making adjustments to and gathering information for antenna parameters of the plurality antennas.

2. The antenna interface system of claim 1, wherein the user interface is an application program interface or a graphical user interface.

3. The antenna interface system of claim 1, wherein the second network connection is an Ethernet connection.

4. The antenna interface system of claim 1, further comprising a third network connection that establishes a communication connection between access device and the server without going through the first network connection.

5. The antenna interface system of claim 1, further comprising a fourth network connection that directly connects the access device and at least one converter of the plurality of converters.

6. The antenna interface system of claim 1, wherein at least one of the converters of the plurality of converters is embedded in a base station transceiver or in at least one antenna of the plurality of antennas.

7. The antenna interface system of claim 5, wherein the access device further comprises a user interface and an antenna control program configured to provide command signals to the plurality of antennas via the fourth network connection.

8. The antenna interface system of claim 7, wherein the access device further comprises application programs, including the antenna control program, stored on a non-transitory computer-readable recording medium, and a processor for executing the application programs so as to provide the command signals to the plurality of antennas.

9. The antenna interface system of claim 1, further comprising a switch configured to be connected between the server and two or more converters of the plurality of converters so as to switch between the two or more converters for sending command signals to antennas of the plurality of antennas that correspond to the two or more converters.

10. The antenna interface system of claim 1, further comprising a database configured to store network parameters and information related to the antenna parameters and the plurality of antennas.

11. The antenna interface system of claim 1, wherein the server further comprises application programs, including the antenna control program, stored on a non-transitory computer-readable recording medium, and a processor for executing the application programs so as to provide the command signals to the plurality of antennas.

12. The antenna interface system of claim 1, wherein antenna parameters related to elevation tilt, azimuth steering, azimuth bandwidth, antenna calibration, information for enabling and disabling an antenna, firmware downloads and antenna inventory information.

13. The antenna interface system of claim 1, wherein the access device is a portable device.

14. An antenna interface device for providing command signals to a plurality of antennas in a wireless network, comprising:
a user interface for providing a communication connection to the antenna interface device from an access device;
at least one antenna control program configured to provide the command signals to the plurality of antennas; and
a network interface configured to establish a network connection between the antenna interface device and a plurality of converters for transmitting the command signals to the plurality of antennas, each converter being located in the vicinity of one or more antennas of the plurality of antennas,
wherein the plurality of antennas are connected to the plurality of converters so as to receive the command signals, the command signals being used for making adjustments to and gathering information for antenna parameters of the plurality antennas.

15. The antenna interface device of claim 14, further comprises application programs, including the at least one antenna control program, stored on a non-transitory computer-readable recording medium, and a processor for executing the application programs so as to provide the command signals to the plurality of antennas.

16. The antenna interface device of claim 14, wherein the user interface is an application program interface or a graphical user interface.

17. The antenna interface device of claim 14, wherein in the network connection is an Ethernet connection.

18. The antenna interface device of claim 14, wherein antenna parameters related to elevation tilt, azimuth steering, azimuth bandwidth, antenna calibration, information for enabling and disabling an antenna, firmware downloads and antenna inventory information.

19. A method of establishing an antenna interface for providing command signals from a server to a plurality of antennas in a wireless network, the method comprising:
establishing a first network connection between an access device and the server;
providing a user interface configured to establish a communication connection between the server and the access device;
establishing a second network connection between the server and the plurality of converters; and
providing the command signals from the server to the plurality of antennas via the plurality of converters,
wherein the plurality of antennas are configured to be connected to the plurality of converters and the plurality of converters are configured to transmit the command signals from the server to the plurality of antennas, each converter being located in the vicinity of one or more antennas of the plurality of antennas and the command signals are used for making adjustments to and gathering information for antenna parameters of the plurality antennas.

20. The method of claim 19, further comprising identifying all the antennas of the plurality of antennas connected to the plurality of converters based on antenna parameters stored in a database, and if not all the connected antennas are able to be identified, creating new antenna parameters in the database for the connected antennas that could not indentified.

21. The method of claim 19, further comprising determining if all the connected antennas are included in the database, assigning a unique address to each of the connected antennas and storing the unique addresses in the database.

22. The method of claim 19, further comprising checking status information related to the plurality of antennas connected to the plurality of converters.

23. The method of claim 22, further comprising determining if the plurality of antennas connected to the plurality of converters are operational, sending a repair message if any antenna of the plurality of antennas is determined not to be operational for a specified amount of time, and sending command signals from the server to the antennas of the plurality of antennas that are determined to be operational.

24. The method of claim 19, further comprising determining if the command signals sent to the plurality of antennas have been executed; and updating the status of the plurality of the antennas in the database.

25. The method of claim 19, wherein antenna parameters related to elevation tilt, azimuth steering, azimuth bandwidth, antenna calibration, information for enabling and disabling an antenna, firmware downloads and antenna inventory information.

26. A program stored on a non-transitory computer-readable recording medium for establishing an antenna interface for providing command signals from a server to a plurality of antennas in a wireless network, the program causing the server to execute steps comprising:
establishing a first network connection between an access device and the server;
providing a user interface configured to establish a communication connection between the server and a user of the access device;
establishing a second network connection between the server and the plurality of converters; and
providing the command signals to plurality of antennas from the server via the plurality of converters,
wherein the plurality of antennas are configured to be connected to the plurality of converters and the plurality of converters are configured to transmit the command signals from the server to the plurality of antennas, each converter being located in the vicinity of one or more antennas of the plurality of antennas and the command signals are used for making adjustments to and gathering information for antenna parameters of the plurality antennas.

27. A method of establishing an antenna interface for providing command signals from an access device to a plurality of antennas in a wireless network, the method comprising:
establishing a first network connection between the access device and the plurality of converters;
providing a user interface configured to establish a communication connection between the access device and the plurality of converters; and
providing the command signals from the access device to plurality of antennas via the plurality of converters,
wherein the plurality of antennas are configured to be connected to the plurality of converters and the plurality of converters are configured to transmit the command signals from the access device to the plurality of antennas, each converter being located in the vicinity of one or more antennas of the plurality of antennas and the command signals are used for making adjustments to and gathering information for antenna parameters of the plurality antennas.

28. A program stored on a non-transitory computer-readable recording medium for establishing an antenna interface for providing command signals from an access device to a plurality of antennas in a wireless network, the program causing the access device to execute steps comprising:
establishing a first network connection between the access device and the plurality of converters;
providing a user interface configured to establish a communication connection between the access device and the plurality of converters; and
providing the command signals from the access device to plurality of antennas via the plurality of converters,
wherein the plurality of antennas are configured to be connected to the plurality of converters and the plurality of converters are configured to transmit the command signals from the access device to the plurality of antennas, each converter being located in the vicinity of one or more antennas of the plurality of antennas and the command signals are used for making adjustments to and gathering information for antenna parameters of the plurality antennas.

29. The antenna interface system of claim 1, wherein the plurality of converters performs communications to and from the plurality of antennas by being configured to:
receive a control message from the server, the control message being encoded into Layer 2 frames and encapsulated in Ethernet message format;
identify the Layer 2 frames from the Ethernet message format;
send the Layer 2 frames to the plurality of antennas using a physical layer protocol in conformance with antenna control specification of the plurality of antennas;
receive reply messages from the plurality of antennas, the reply messages being encoded into Layer 2 frames sent using the physical layer protocol in conformance with the antenna control specification of the plurality of antennas;
encapsulate the Layer 2 frames of the reply message in Ethernet message format; and
send the Ethernet message format representative of the replay message to the server.

30. The method of claim 19, wherein communications between the plurality of converters and the plurality of antennas are performed by:
receiving a control message from the server, the control message being encoded into Layer 2 frames and encapsulated in Ethernet message format;
identifying the Layer 2 frames from the Ethernet message format;
sending the Layer 2 frames to the plurality of antennas using a physical layer protocol in conformance with antenna control specification of the plurality of antennas;
receiving reply messages from the plurality of antennas, the reply messages being encoded into Layer 2 frames sent using the physical layer protocol in conformance with the antenna control specification of the plurality of antennas;
encapsulating the Layer 2 frames of the reply message in Ethernet message format; and
sending the Ethernet message format representative of the replay message to the server.
